(19) United States
(12) Patent Application Publication
(10) Pub. No.: US 2019/0164148 A1
(43) Pub. Date: May 30, 2019

(54) SYSTEM AND METHOD FOR PROVIDING A VIRTUAL GIFT CARD EXCHANGE BANK

(71) Applicant: Steven Suh, Frisco, TX (US)

(72) Inventor: Steven Suh, Frisco, TX (US)

(21) Appl. No.: 16/196,369

(22) Filed: Nov. 20, 2018

Related U.S. Application Data
(60) Provisional application No. 62/592,168, filed on Nov. 29, 2017.

(51) Int. Cl. G06Q 20/34; G06Q 30/02; G06Q 20/40

(52) U.S. Cl. CPC G06Q 20/342; G06Q 20/4016; G06Q 30/0207; G06Q 30/0283

(57) ABSTRACT

A virtual gift card bank buys gift cards discounted from their face value. These gift cards are bought from secondary gift card vendors or from individuals looking for cash or an exchange. A large bank of gift cards is compiled, consisting of cards purchased by the bank and cards uploaded by various sellers. Then consumers are offered use of these gift cards at prices less than the face value but with profit added to the transaction. When possible the bank combines multiple little gift cards into one big one. A consumer only needs his smart phone to utilize any gift card in the database to purchase goods at a discount, sell unwanted gift cards, and deposit his monies into his bank accounts. Subsystems include inquiries into retailer systems to ascertain gift card values, performance of anti-fraud services to retailers, and on the fly valuation of optimal buy and sell prices.

### CROSS REFERENCE APPLICATION

The present non-provisional application claims priority to provisional application No. 62/592,168 filed Nov. 29, 2017 which is incorporated herein by reference in its entirety.

### FIELD OF INVENTION

The present invention relates to buying in bulk gift cards in the secondary gift card marketplace at a price less than face value, and then providing a virtual store to consumers to shop for a gift card priced under the face value but over the price paid for the gift card.

### BACKGROUND OF THE INVENTION

Gift cards and gift codes are widely used as a gift for birthdays, Christmas, and other holidays. Gift cards and gift codes are closed loop, meaning that the value represented by a gift card or gift code is a valid form of payment at a closed set of retailers. For example, an Outback Steakhouse® gift card/code is only redeemable at Outback Steakhouse® and not at Planet Hollywood® or Target®.

Some closed loop cards and codes are valid at a family of closely related or commonly owned merchants. For example, a Darden Restaurants gift card/code is valid at Red Lobster® and Olive Garden®, or a local mall gift card/code is valid at tenant merchants in the local mall. Open loop gift cards (and gift codes), in contrast, are a valid form of payment at virtually every retailer nationwide, such as Visa® or MasterCard® debit cards.

Gift cards/codes are a popular alternative to giving cash or a merchandise item that the recipient may or may not like. However, the recipient may not be able to redeem the gift card/code due to geographic limitations, personal disinterest in the merchant who issued the gift card/code, or other reasons. Additionally, some merchants issue gift cards/codes with significant restrictions, complex fees, and/or an expiration date. According to one estimate, consumers purchase about $80 billion worth of gift cards annually in the U.S. and roughly 10%, or $8 billion, of that amount goes unredeemed. Consumers waste these unredeemed funds and do not benefit from the value of the gift card/ code. Further, if these funds are not spent, they can escheat to the state. Merchants cannot track post-issuance gift card transactions that do not involve the issuing merchant.

Sometimes only a trivial amount of money is left on the gift card. The owner decides it is not worth the effort of buying an item and using up this trivial amount. Thus, the card is discarded, wasting money. A method is needed to save this loss.

Sometimes an owner of a grocery gift card wants to buy a tennis racquet. Thus, the owner needs a way to “trade in” his grocery card for a Dick's Sporting Goods® card.

The present invention provides the consumer with a virtual gift card exchange bank to accomplish the above noted needs.

### SUMMARY OF THE INVENTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Some consumers resell or exchange their unwanted or unusable gift card/codes in what is termed a secondary marketplace. The secondary marketplace is a collection of transactions involving gift cards and/or gift codes which do not involve an original gift card or code issuer. For example, Sears issues a $100 gift card to a Mary. Mary gives the gift card to Larry. Larry uses $50 of the gift card to purchase merchandise from Sears. That use of the gift card is not part of the secondary marketplace because it involves the gift card issuer, Sears. Other transactions that Larry conducts with the remaining balance are part of the secondary market. For example, if Larry sells the $50 balance remaining on the gift card for $35 in cash, that transaction is part of the secondary market. If Larry divides the $50 balance remaining on the gift card into two $25 gift cards, that transaction is part of the secondary market because it does not directly involve the gift card/code issuer.

The merchants who originally issued the gift cards or codes are unable to track this secondary gift card/code market in any meaningful way, potentially leading to lost revenues and marketing opportunities.

The disclosure first discusses an exemplary system and various components thereof that address these issues. The disclosure then turns to a more specific example configuration of how a secondary market for gift codes and gift cards can operate. The disclosure demonstrates an example merchant interface for tracking the secondary market. Finally, the disclosure turns to the exemplary method embodiment.

The main aspect of the present invention is to provide a virtual bank of gift cards that are available for purchase at a price higher than the purchased price yet still lower than the gift card face value.

Another aspect of the present invention is to provide a consumer with a smart phone application to execute all consumer based features.

Another aspect of the present invention is to combine multiple gift cards into one high value card where issuers so permit.

Another aspect of the present invention is to track geo-location data of the consumer to offer that consumer nearby deals.

Another aspect of the present invention is to provide inquiries into card issuers such as Sears® to ascertain the outstanding balance of a gift card without the need to swipe it.

Another aspect of the present invention is to detect a forthcoming bankruptcy, expiration deadline, going out of business sale or the like, and adjust the selling price of the inventory of those cards accordingly to prevent a valueless inventory.

Another aspect of the present invention is to automatically transfer consumer funds in and out of the consumer's bank and credit card accounts in a pre-programmed logic.

Another aspect of the present invention is to provide a method comprising collecting data of multiple transactions in which consumers, as non-issuers of gift cards, in a secondary market, resell the gift cards for use by other consumers for at least one of cash, goods and services to yield collected data, wherein gift card issuers and merchants do not participate in secondary market transactions; aggregating, via a computing processor, the collected data to yield aggregated data; and presenting, via a user interface on a computing device, a report comprising at least a portion of the aggregated data.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 is a schematic overview of the gift card discount purchase system using gift cards.

FIG. 2 is a graphic overview of the secondary gift card market used to pay a merchant.

FIG. 3 is a chart of the gift card secondary market size.

FIG. 4 is a flowchart of a price algorithm.

FIG. 5 is a flowchart of a gift card buyback subsystem.

FIG. 6 is a sample photo of a gift card.

FIG. 7 is a flowchart of consumer purchase using the gift card bank.

FIG. 8 is a graph of a secondary market pricing algorithm.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

### DEFINITIONS

ACH: Automated Clearing House

API: application programming Interface

GC: Gift Card

IVR: interactive voice response

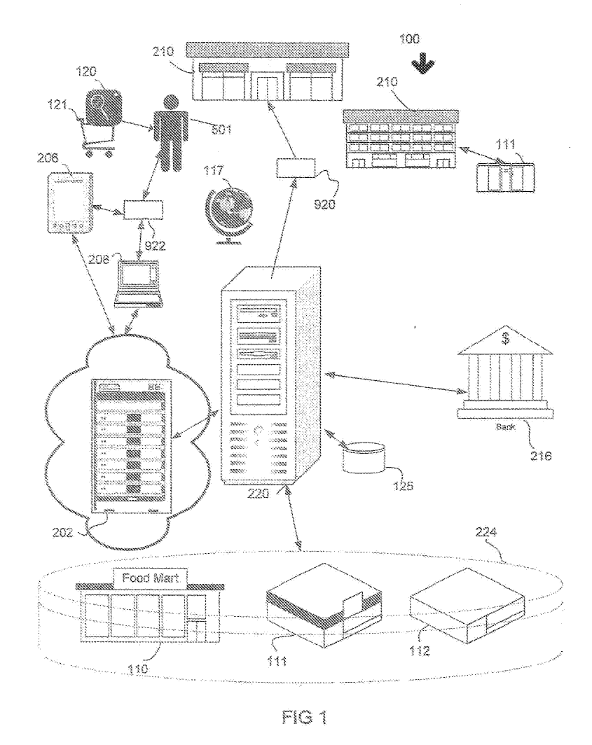

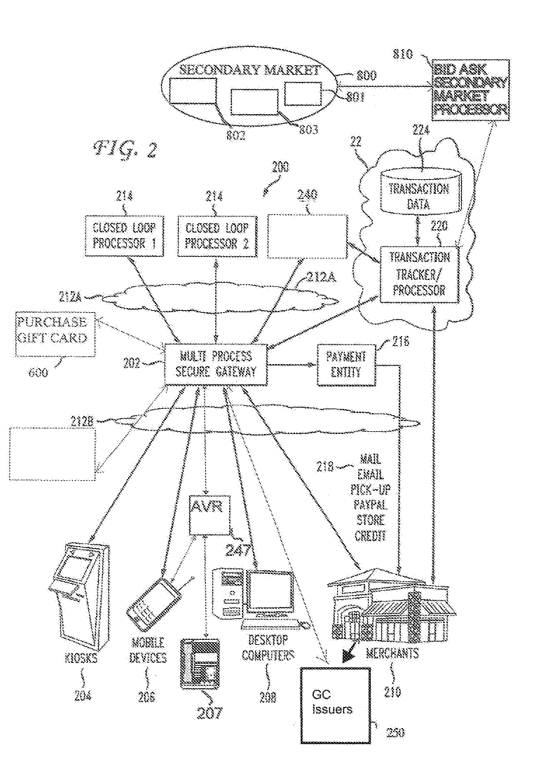

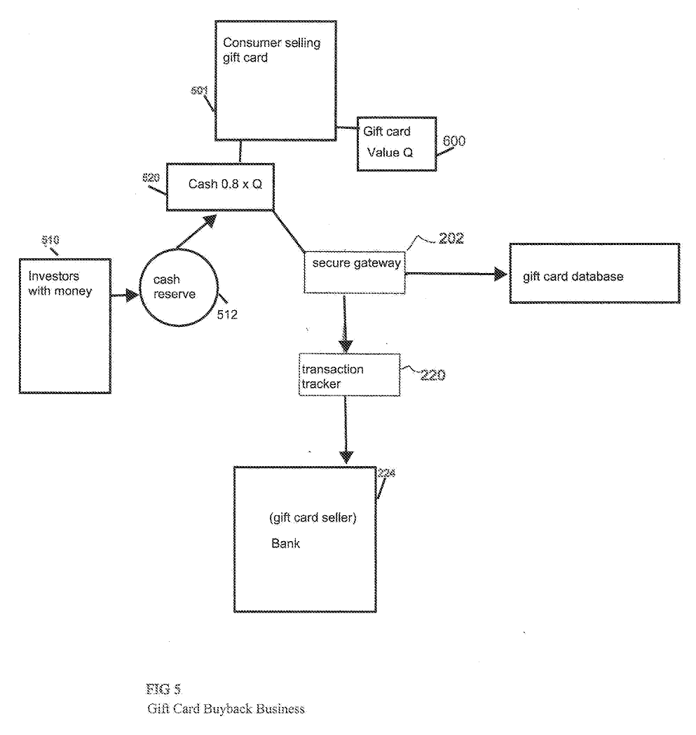

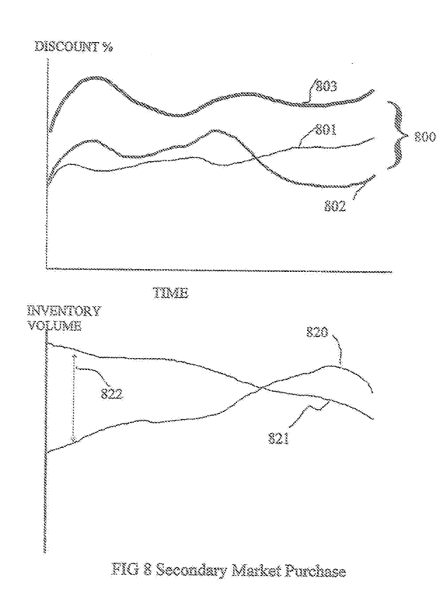

FIG. 1 is a graphic overview of the essential elements of the product discount purchase apparatus using aggregated Gift Cards. Customer 501 desires to purchase product or service 120 at cost 920 typically thru customer's smartphone 206 or computer 208 running a secure Penney (trademark for present invention) application communicates to secure gateway 202 linked to transaction processor 220 to check discount 922 availability at particular merchant 210. Transaction processor 220 checks current Gift card inventory 110-112 organized by merchant stored in database 224 that quantify or meet rules for instant purchase of item 120 in application shopping cart 121. If inventory 224 is adequate for purchase customer 501 is notified of available discount 922 if any via typically smart phone 206. The instant Penny application permits purchasing goods at discount in real time at point of purchase new to the art. An aggregate discount 922 is computed from typically a number of small denominations 600 (FIG. 2) to reach purchase to total 920. FIG. 5 teaches how additional unwanted gift cards are purchased from marketplace. Similarly, FIG. 8 teaches how secondary marketplace is optimally shopped to discover best price to replenish GC inventory. New to the art customer 501 has a high probability of discount 922 availability in Real-time i.e. at check-out/point of purchase from a wider array of merchants 210, while instant apparatus 100 (totality of the Penny system) maintains optimal GC inventory 224 levels for lower operation cost. Application processor 220 with geo-location data 117 from cell phone 206 or other location services may also check merchant web site 111 for in store promotions and discounts offering customer greatest possible discount.

Thus, customer 501 saves a great deal of time spent searching many secondary sources for discounts. If customer 501 chooses to make purchase at discounted rate 922, transaction processor 220 debits customer's account 125 via ACH from bank or credit sources 216.

Settlement of total purchase 920 with GC from inventory 224 is done with merchant 210 in real time or daily batch via Transaction processor 220. Transaction processor 220 via semi-custom API for each merchant and or card issuers handles zeroing card balances, reissue GC for fraction unused and general accounting functions. The disclosure now turns to FIG. 2 which illustrates a multi-process secure gateway configuration 200 including a transaction tracker/processor 220. The multi-process secure gateway 202 can be implemented as a local or remote server, a group of tightly or loosely interconnected servers, integrated as a software module within a point of sale device, or as any other suitable device, software, or combination thereof. In FIG. 2, the multiprocess secure gateway 202 is shown as a single conceptual server available over a network 212B such as the public telephone network (PTN) or the Internet. The multiprocess secure gateway 202 interacts with various requesters, such as kiosks 204, smart mobile devices 206, desktop computers 208, GC issuers 250, Bank/Credit-card processors 216, and merchants' point of sale devices 210, which submit information uniquely identifying closed loop cards/codes. Mobile device 206 can also represent a standard telephone as well as communication with an interactive voice response (IVR) system.

Each of these devices can interact with the secure gateway 202 through different protocols, such as a direct network connection, an HTTP-based portal, SMS messages, email, telephone, interactive voice response systems, point-of-sale (POS) terminals, etc. In the case of merchants, each point of sale of the merchant 210 can connect to a centralized merchant server, not shown, which relays requests to the secure gateway 202 on behalf of all the merchant 210 point of sale devices. Other configurations also exist. The transaction processor 220 settles the customer purchase by aggregation of GC from other customers via transaction processor 220 (FIG. 2) or secondary market 800 (FIG. 8) placing GC into local inventory 224.

In one aspect, this process is called “Penny” (name used for description purposes only). Merchants 210, kiosks 204, other devices and/or locations, including online storefronts, which provide an interface to the secure gateway 202 can provide an easily recognizable visual or other indication readily indicating to potential customers that they accept gift cards/codes under the Penny program. The indication can be a window sticker, an online image, or other sign displayed in a manner similar to the well-known overlapping circles for MasterCard® or the blue and orange bars over and under the word VISA®. Penny has transaction processor as taught in FIG. 5. that purchases unwanted GC 600 from customers. Penny leverages the larger inventory of GC from many secondary market 800 vendors to offer a greater number of products and services to it customers. By keeping a small dynamic instantly available inventory customers can use discounts in real time at Merchant 210 point of sale via e-GC sent to phone 206 via SMS e-mail or voice prompt for visually impaired. Current state of art has delays of hour to days after card purchase and redemption. Transaction processor 220 uses customers balance and credit card on file to purchase desired amount of discounted GC typically the full purchase amount. Transaction processor combines one or more GC into one e-GC typically a 16 digit number presented to merchant at point of sale. Transaction processor 220 via secure gateway 202 settles e-GC with merchant payment entity 216 and or GC clearing issuing house 250. Transaction processor 220 via API reconciles the GCs in inventory used to make each purchase typically in a batch mode once per day. The secure gateway 202 interacts with multiple closed loop processors 214, such as FirstData, Moneris and Chase Paymentech, over a network 212A such as the Internet. These closed loop processors 214 are algorithms that process closed loop cards The secure gateway 202 can perform any action on the closed loop card/code through the various closed loop card/code processors 214 as if the secure gateway 202 was a closed loop merchant. The secure gateway 202 analyzes the submitted information to determine which closed loop processor handles that type of closed loop card/code. For example, a particular series of numbers or letters can indicate that one closed loop card/code is honored by Paymentech, and another distinct set of numbers or letters indicates that another closed loop card/code is honored by FirstData. The logic and analysis in the secure gateway 202 can change from time to time as new types of cards/codes are issued by existing closed loop processors 214 or as the secure gateway 202 adds interfaces for new closed loop processors. The secure gateway 202 can include a common application programmer interface (API) which defines actions which may be performed through the closed loop processors 214. The API translates API calls to the corresponding specific sets of proprietary interactions with the various closed loop processors 214, which may be very different between closed loop processors 214.

Similarly closed loop processors via custom API settle transactions with merchants 210 and payment entity 216. The secure gateway 202 determines the balance of the closed loop card/code from the closed loop processor 214 and offers to purchase the closed loop card/code from the customer, typically at a price lower than the face value of the card/code (though not always and can be at or above the face value). If the customer provides an indication of agreement to sell the closed loop card/code, then the secure gateway deactivates the closed loop card/code associated with the submitted information, issues a new closed loop card/code in that amount (which may be a physical closed loop card/code or a virtual closed loop card/code), and pays the purchase price to the customer through a payment entity 216. The payment entity 216 can be a merchant that pays the customer while another entity settles with the merchant. The gateway 202 can also provide instructions to other entities to perform the deactivation, issuance, payment, and other steps. The payment entity 216 can be part of the secure gateway 202, part of a merchant point of sale equipment 210, or a separate entity altogether. The secure gateway 202 can provide additional instructions regarding how to transfer payment 218 to the customer. Some examples of how to transfer payment include mailing a physical open loop card/code to the customer, emailing to the customer the necessary information to use a non-physical open loop card/code (such as an account number and PIN), notifying a local financial service to prepare an amount of money for pickup (such as MoneyGram or Western Union), transferring funds to an electronic account (such as PayPal), transferring money to a customer's existing open loop card/code (such as an OmniCard or other debit card/code), adding funds to an existing credit card or debit card, any other form of electronic funds transfer (EFT), or granting store credit or any other form of currency usable at a store to the customer. The payment entity 216 can also provide payment to the customer using other suitable approaches. Transactions processed through the secure gateway 202 constitute part of the secondary market if they do not directly involve the gift card issuer. The transaction tracker/processor 220 can receive and/or retrieve information regarding completed, in-process, and/or attempted transactions from the secure gateway 202. Automatic Voice Recognition system (AVR) 247 allows visually impaired customers to use Cell or telephone 207 as front end to Gateway 202 and Transaction processor 220 to allow card balance check and conduct other transaction.

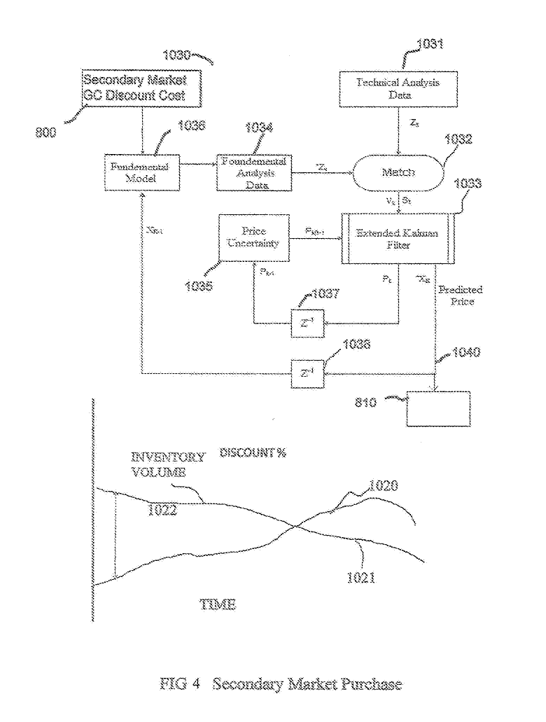

The transactions with the secure gateway 202 represent the secondary marketplace for gift cards and gift codes. In the secondary marketplace, non-original issuers of gift cards and codes sell and/or trade the gift cards for cash or for other goods or services. The transaction tracker/processor 220 can be incorporated as part of the secure gateway 202 or can be a separate entity communicating through a network 22 as shown in FIG. 2. The transaction tracker 220 processes the secondary marketplace transaction information and stores all or part of the processed information in a transaction data repository 224. The transaction tracker 220 can aggregate all or part of the received data, and can categorize data by date, geographical region, type of gift card or code, gift card face value, gift card redemption value, customer habits, whether or not a portion of the gift card had been used, whether a customer is participating in the secondary gift card market for the first time, what the gift card was sold for (i.e. was the gift card exchanged at a merchant, for another gift card, split into smaller denominations, etc.), and so forth. The transaction tracker 220 can provide closed loop processors 214, merchants 210, and/or other interested or involved entities an interface to view, sort, analyze, and otherwise manipulate the stored transaction data 224. In one aspect, a merchant 210 can view detailed information regarding individual transactions associated with gift cards/codes issued by that merchant 210, but only broad statistical data regarding gift cards/codes issued by other merchants. Transaction processors 220 generate volume analytics used by secondary purchase algorithm 800 (FIG. 8) to estimate GC inventory buffer size, Bid prices and incentives to GC purchase module 1030 (FIG. 4). In one aspect, the transaction tracker 220 provides a web-based user interface. The interface can allow closed loop merchants to compare aggregated statistics to their own statistics. For example, a nationwide office supply retailer can compare the secondary market statistics for their own gift cards to the secondary market of other nationwide office supply retailers to determine trends. The retailer can then exploit these trends with marketing campaigns, in-store promotions, online ads, or other methods. The transaction tracker 220 can also collect personally identifiable information, such as a phone number, email address, or credit card number associated with each transaction. However, for the sake of privacy, the transaction tracker 220 can strip this information out when providing reports through the interface to the various requesting entities. In one aspect, the transaction tracker 220 offers a user a more favorable price for the gift card on the secondary market in exchange for more detailed personal and/or demographic information. For example, the secure gateway 202 offers a user $34 in cash for a $50 gift card. However, if the user agrees to spend a few minutes to fill out a survey and divulge some more detailed personal information, the transaction tracker 220 can authorize the secure gateway 202 to offer the user $38 in cash instead of $34 or greater discounts and or greater credit from purchase module 800 (FIG. 8).

The transaction tracker 220 can also track redemption specific data such as at which specific stores or websites the cards or codes are redeemed. In the case of online redemption, the transaction tracker 220 can track referral websites (i.e. which site referred the customer to the online redemption page). The transaction tracker 220 can disclose all, part, or none of this information to merchants. In one brick and mortar merchant example, if a large number of customers redeem their closed-loop cards and codes at Wal-Mart and Target, the transaction tracker 220 can provide this information to either Wal-Mart or Target so that they can approach issuers of the redeemed cards regarding potential cooperative marketing opportunities. The transaction tracker 220 can track data indicating which individual store sold each redeemed card or code. Such data allows merchants to identify the origin of redeemed cards through an interface such as the one shown in FIG. 2. For instance, Best Buy can log into the merchant interface and see data indicating from which specific stores and/or states the secondary market gift card originated. If the data show a large volume of food cards purchased in the secondary marketplace maybe that is an indication that customers are purchasing for storm victims. Special marking or promotions can be started to help bring awareness to the issue. Additionally, as with virtually any marketplace, one concern is how to detect and prevent fraud in the secondary gift card and gift code marketplace. In one aspect, the transaction tracker 220 tracks and provides information to merchants about fraud related or potentially fraud related trends or individual transactions. For example, if the secure gateway 202 of FIG. 2 processes cards that stolen, the transaction tracker 202 can identify the location, date, time of day, and other information that may be valuable to Merchants. Similarly, some customers attempt to obtain “store credit” via fraud. The transaction tracker 220 can include a fraud alert module 240 that compares transaction information against informational templates which may be indicators of fraud. Alternatively, the transaction tracker 220 can provide the available information to a user without further fraud analysis so that the user can make investigate potential fraud issues.

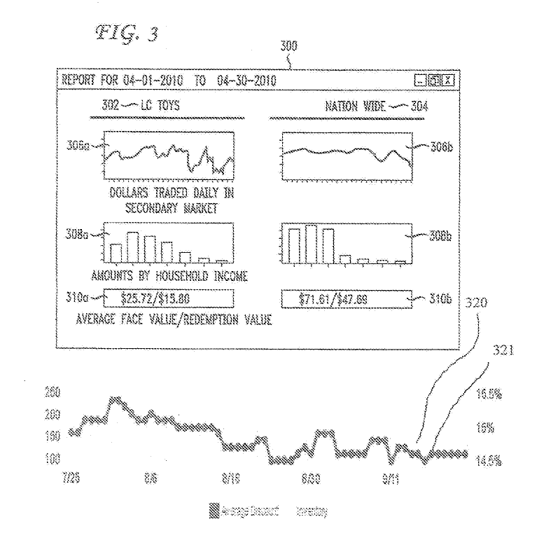

Additional embodiments and variations related to detecting, flagging, and preventing fraud are discussed below. FIG. 3 illustrates an exemplary merchant interface 300 for tracking the secondary market. The interface 300 can be part of a computer application, a web application, client-server application, etc. In one aspect, merchants 210 create an account with a server providing the merchant interface. Merchants then log in using a secure connection to the server. A merchant can track various statistics regarding the secondary market for gift cards associated with that merchant. FIG. 3 shows a user interface 300 displaying charts and reports based on secondary gift card market data for an example merchant LC Toys 302 and the nationwide 304 secondary gift card market.

Customer wishing to make purchase of amount N from merchant 210 (FIG. 2) transaction processor 220 checks inventory 224 of GC supported by merchant 210 if in inventory customer is informed of discount(s) available. If GC not in inventory 224 Penny secondary marketplace transaction processor 810 shops secondary market 800 for available GC meeting customers purchase requirements if located customer is informed of discount availability. If customer accepts offer via gateway 202 and transaction processor 220 secondary marketplace transaction processor 810 checks current discount 310a and 310b (FIG. 3) offered by secondary vendors 801-3. GC prices from secondary market are time variant for example some vendors may have large inventory 321 of a particular GC this discount may be greater with larger inventory. FIG. 2 teaches how the secondary market adaptive transaction processor 810 shops secondary market 800 for best price and can offer a large array of GC from many merchants while keeping inventory at optimal levels. FIG. 5 Teaches GC transaction flow. Customer 501 has option of depositing GC 600 into customer's account database 224 or can exchange GC for cash at rate 520. Investors 510 purchase GC 600 at discounted rate 520 from customer 501 or cards are purchased via cash reserve 512. GC 600 are purchased thru a secure gateway 202 transaction is forwarded to transaction processor 220 then stored to database 224 storing customer accounts.

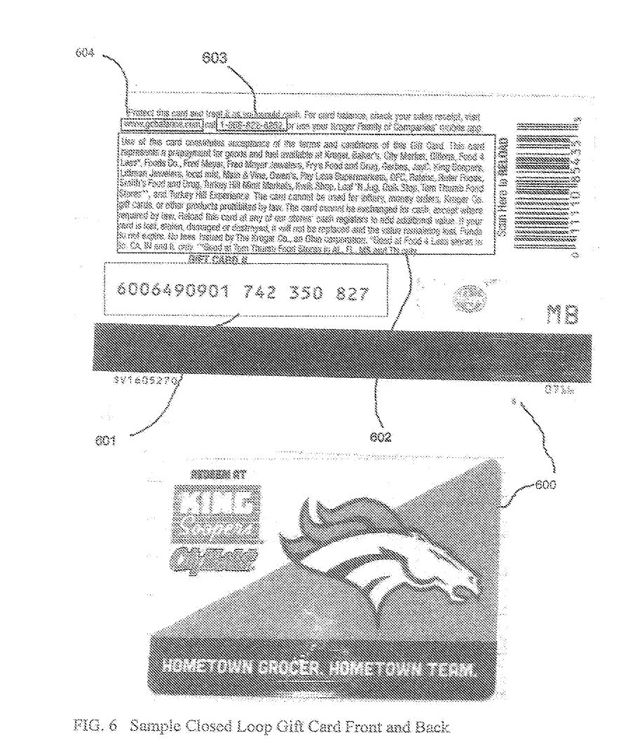

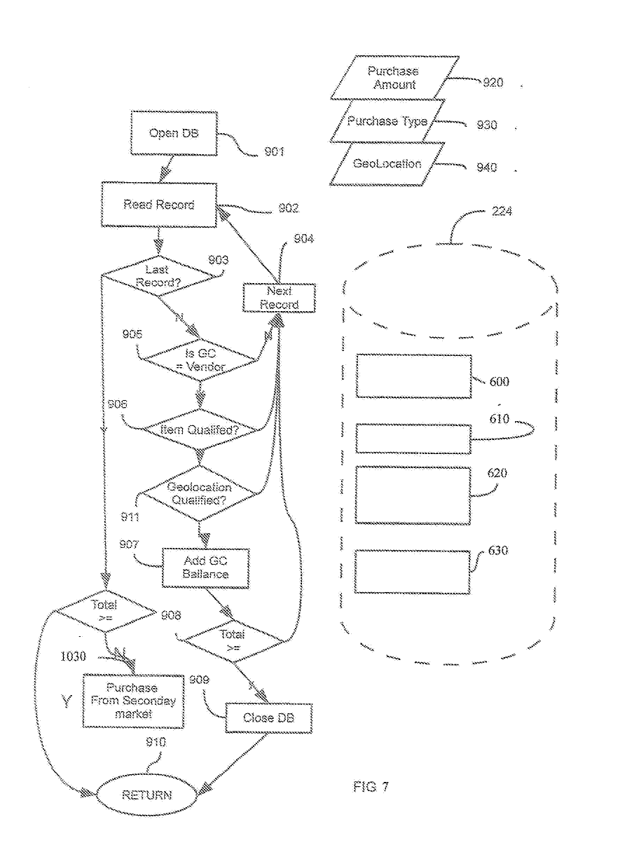

Some GC rules 602 (FIG. 6) permit combined balances, however, most do not. When customer 501 is making a purchase amount 920 (FIG. 5) at discount, transaction processor 220 taught in FIG. 5 searches GCs (600,610,620,630 FIG. 7) in current inventory 224 (FIG. 2) and customers account. Once purchase amount 920 is located part of database 224 as taught in FIG. 7 customer can make purchase.

The instant invention has the novel feature of transparently combining GCs as taught in FIG. 5 to permit customer 501 to make purchase at current discount rate 821 (FIG. 8). Transaction processor 810 shops secondary market 800 via a bid ask method as taught in FIG. 8 for best current GC price discovery. Based on current market trends and purchase volume transaction processor 810 (FIG. 2) adaptive algorithms can discover best discounts for customer. Transaction processor 810 can also query merchant 210 (FIG. 2) in real-time for current discounts/promotions that may be greater than secondary market 800.

FIG. 6 is a sample of a typical Closed Loop Gift Card Front and Back. Physical Card 600 has no printed value however the card balance can be checked via merchants web 604 address or phone number 603 via automatic Voice Recognition system (AVR) 247 (FIG. 2). Rules restrictions 602 and participation stores are listed on back side of card with card number 601. GC are purchased at discount for cash as taught in FIG. 5 via secure gateway 202 (FIG. 2) and transaction processor 220 and stored in database 224. Closed-loop processor 214 (FIG. 2) insures GC 600 is redeemable per issuing merchant 210 Rules restrictions 602 FIG. 6.

One of the novel aspects of the Penny application is maintaining a small optimal GC inventory while offering a large array of GCs from many vendors to the shopper in real time.

Transaction processor 810 using sales volume and geographic analytics 224 generated by transaction processors 214, 220 (FIG. 2) estimates size of GC inventory needed to timely process customer orders.

Using well known in the art adaptive algorithms such as state space, Kalman, linear predictive type filters are used to discover best price in secondary market 800 and pass on saving to customer 501 (FIG. 1). Current discount rates 801,802, 803 vary with market conditions, individual vendor promotions, inventory levels etc. . . Discount level 820 is often inversely proportional to GC Inventory level 821 with larger discounts 822 offered with larger inventory of secondary GC vendors. This way transaction processor 810 can discover the best price (discount) for customer across many vendors 800.

The current art secondary suppliers such as abcgiftcards.com and giftcards.com 801-3 offer e-cards but delay card deliveries for a few hours to days. Penny fraud control module 240 (FIG. 2) has done verification checks of customer 501 (FIG. 1) so transaction processor 220 as taught in FIG. 2 can complete transaction for customer in real time. Then transaction processor 220 can settle purchase amount 920 with merchant 210 (FIG. 2) and card issuers 250 in batch mode at end of day or in real-time depending on payment method via each merchants particular API.

The instant invention allows customer to realize greatest purchase discount in real time. Novel transaction processor as taught in FIG. 7 transparently concatenates GC in active inventory if instant inventory cannot support purchase amount 920 (FIG. 7) transaction processor 810 acquires additional GC from secondary market 800 in real-time. Also novel customers purchase is transparently settled with appropriate payment entity 216, merchant 210 or card issuer 250, providing a unique real-time discounted shopping experience for customer by freeing the customer the troubles of searching many sites for discounted GC and then waiting for current art GC delivery that may be twenty four hours or longer. FIG. 7 flow chart gift card purchase processing and Penny Application Account balance database processor.

Data base 224 is an inventory of a number of gift cards (GC 600, 610, 620, 630) purchased via GC buyback process as taught in FIG. 5. Database 224 is opened in operation 901 record is read 902 operation 903 checks if end of database 224 was reached if true operation 1030 FIG. 7 purchases the difference between requested Total 920 and total found in 224 with operation 907. Operation 905 checks if record is of the vendor type needed for the purchase if not operation next record 904 is executed. Operation 906 checks if item type 930 qualifies per GC rules 602 (FIG. 6) is of the type needed for the purchase if not operation next record 904 is executed. Operation 911 checks if record vendor is geographically qualified 940 per rules 602 if not operation next record 904 is executed. If GC matches rules total is incremented by GC value 907. Operation 908 checks whether the total is greater than or equal to total required for purchase quantity 920. Once total 920 is reached program flow closes database 224 executes return 910.

FIG. 4 shows the optimal GC acquisition module. Merchant analytics 306A, 306B (FIG. 3) are computed from transaction data 224 (FIG. 2) totals by merchant are computed 1021 FIG. 4. Historical volume is used to estimate size of inventory buffer 1021 secondary purchasing module 810 (FIGS. 4, 8) uses adaptive filters 800 to discover best GC price and acquire additional GC for inventory required for real time transaction settling. By way of example and not limitation transaction processor 220 (FIG. 2) once per-day when setting transactions with merchant 210 and card issuers 250 computes volume by merchant 1020 compares current inventory level 821 (FIG. 8) to volume. If inventory is less than threshold secondary market 810 processor is instructed to purchase more GC from open market. Current ask prices are posted by vendors 801-803 via WEB interface or obtained via custom Application Programming Interface (API). Rule algorithm script determines lowest current price and offers an amount less than proportional to number of GC to be purchased; i.e., bulk purchase offers lower price. After all secondary vendors 801-3 have replied to BID query or time has expired script selects best ask offer. If ask price is greater than bid, bid price is incremented and the process is repeated until a price is agreed upon. GC are purchased by payment entity 216, once payment has cleared transaction processor 810 places GC into inventory 224 via transaction processor 220.

GC such as offered by Kroger Corp example (FIG. 6) may be used at national Kroger and regional affiliate stores such as, Baker's, City Market, Chllons, Food 4 Less', Foods Co., Fred Meyer, Fred Meyer Jewelers, Fry's Food and Drug, Gerbes, jayC, King Soopers, Littman jewelers, local mkt, Main & Vine, Owen's, Pay Less Supermarkets, QFC, Ralphs, Ruler Foods, Smith's Food and Drug, Turkey Hill Minit Markets, Kwik Shop, Loaf 'N jug, Quik Stop, Tom Thumb Food Stores”, and Turkey Hill Experience. Customer using mobile device 206 API and current device's geographic data (GPS, GNS, Cell tower, etc.) can locate participating stores near the customer.

However, example GC 600 (FIG. 6) Kroger by way of example has additional geographic restriction like “Good at Food 4 Less stores in So. CA, IN, and IL only.” Or, “Good at Tom Thumb Food Stores in AL, FL, MS and TN only.” Closed loop processor 214-215 (FIG. 2) business rules logic addresses the time, geographic, and merchandise type such as lottery, money orders, other gift cards, or other products prohibited by law. The card cannot be exchanged for cash, except where required by law.

Penny GC purchase 810 (FIG. 8) application looks at current inventory 224 (FIG. 2) if it can offer customer greater price for a particular merchants GC. By pooling transaction volume a larger quantity of GCs may be purchased at once using a BID ASK method with secondary vendors 801-3.

Secondary marketplace transaction processor 810 (FIG. 8) shops secondary market 800 for available GC meeting customer's requirements if located customer is informed of discount availability. If customer accepts offer via transaction processor 220 secondary marketplace transaction processor 810 checks current discount 310 (FIG. 3) offered by secondary vendors 801-3. This way using adaptive filters 1030 to shop secondary market and search bots to locate merchant promotions customers are offered attractive discounts available in real time at check out, an improvement in current art. Application transaction processors 220 (FIG. 2), 810 (FIG. 2) and secure gateway 202 manage GC acquisition, inventory levels, real-time or batch settlement with Merchants 210, payment entities 216 and GC issuers 250.

The GC database will have two types of card information entered: (1) gift cards that Penny has purchased, and (2) gift cards that sellers have uploaded into the database for sale via their mobile devices 206 (FIG. 2). The reimbursement for the GCs uploaded by sellers will be structured to incentivize the sellers with 1% or 2% additional yield when compared to GCs directly purchased by Penny. Such arrangement is designed to give higher values for the sellers and to lower the inventory of GCs, which in turn will lower Penny's operating costs.

I claim:

1. An internet based secondary market financial system comprising:
a gift card bank that buys and sells gift cards individually and in bulk;
said gift card bank having interfaces with a plurality of gift card issuer;
said gift card bank having an inquiry subroutine to the plurality of gift card issuers to gather permission or denial to group multiple gift cards from a single gift card issuers into a new single gift card;
said gift card bank compiling an inventory of gift cards of both an open and a closed loop type;
said gift card bank having a computing subroutine to compute a resale price of each gift card in its inventory that is higher than a purchase price of the gift card and lower than a face value of the gift card;
a consumer mobile application that has a communication link to a merchant sales system;
said consumer mobile application having a communication link to the gift card bank to purchase an item from the merchant sales system using a gift card purchase from the gift card bank inventory.

2. The financial system of claim 1, wherein the consumer mobile application further comprises a communication link to at least one member of a group consisting of a consumer credit card, a consumer bank account and a consumer credit union account.

3. The financial system of claim 2, wherein the consumer mobile application has a subroutine to permit a purchase from the merchant sales system using a combination of a purchase from the gift card bank and a withdrawal from the group.

4. The financial system of claim 1, wherein the inquiry subroutine to the plurality of gift card issuers further comprises a fraud detection subroutine to detect a fraudulent gift card.

5. The financial system of claim 1, wherein the computing subroutine further comprises a discount algorithm to reduce the resale price as a gift card expiration date approaches.

6. The financial system of claim 1, wherein the consumer mobile application further comprises a subroutine to select a merchant allowable group of closed and open loop gift cards from the gift card bank.

7. The financial system of claim 1, wherein the consumer mobile application further comprises a geography based subsystem that retrieves and displays a local special sale from a plurality of local merchants.

8. The financial system of claim 1, wherein the gift card bank further comprises a link for a consumer mobile application to shop from a gift card vault which comprises a group of gift cards for sale.

9. The financial system of claim 8, wherein the gift card vault further comprises a bidding subroutine to enable a gift card seller to discount a resale price using a criteria.

10. The financial system of claim 9, wherein the criteria includes a time based discount.

11. The financial system of claim 1, wherein the gift card bank further comprises a normalization subroutine to standardize a plurality of different gift card codes.

12. The financial system of claim 2, wherein the consumer mobile application further comprises a buy back subroutine to the gift card bank to enable a sale of a consumer gift card to the gift card bank and a money transfer into the consumer group.

13. A secondary gift card market exchange system comprising:
a central bank exchange database which stores and processes purchased gift card (GC) files;
said central bank exchange having a subsystem to communicate with a plurality of gift card issuers;
said subsystem having a fraud detect subroutine;
a gift card purchasing subsystem that interactively buys gift cards either individually or in bulk at a price less than a face value of the gift card;
a pricing subsystem that establishes a resale price of a gift card in inventory;
a gift card merger subsystem which creates a temporary single large pseudo-gift-card from multiple small cards to pay for a merchandise costlier than a usual face value of a GC;
a gift card sales subsystem that sells or exchanges a gift card with a consumer;
an interactive user interface that coordinates a consumer purchase from the central bank exchange database with a consumer's mobile application;
said consumer mobile application having a direct interface to a consumer's selected bank and credit card accounts;
a retailer inquiry subsystem that ascertains a gift card value as well as its authenticity; and
said pricing subsystem having a gift card expiration subsystem that adjusts a purchase and a sales price based on an anticipated zero value date approaching.

14. A secondary gift card market exchange system comprising: a central bank exchange database which stores and processes:
1. purchased gift card files or information,
2. uploaded gift card for sale information, by sellers;
a gift card purchasing subsystem that interactively buys gift cards either individually or in bulk at a price less than the face value of the gift card;
a pricing subsystem that establishes a resale price of a gift card in the database of acquired gift cards;
a gift card merger subsystem which creates a temporary single large pseudo-gift-card from multiple small cards to pay for a merchandise costlier than the usual face value of GC;
a gift card sales subsystem that sells or exchanges a gift card with a consumer;
an interactive user interface that coordinates all transactions with a consumer's smart phone application or other viable computing devices;
said consumer smart phone application having a direct interface to the consumer's selected bank accounts, credit card accounts, or other payment accounts; a retailer inquiry subsystem that ascertain a gift card value as well as its authenticity; and
a gift card expiration subsystem that adjusts a purchase and a sales price based on an anticipated zero value date approaching.

15. The gift card market exchange system of claim 14 further comprising a server or cloud based Vault comprising a database where all gift cards purchased, uploaded for sale by various GC sellers and/or merchants who want to promote their business is displayed;
a valuation subsystem linked to the Vault that will adjust on the fly purchase prices and selling prices of various GCs in order to improve efficiency;
a storage subsystem that will translate photos of GCs and user specified alphanumeric strings that correspond to each GC, into a database file that will permit retrieval by various computing devices;
an implemented multi-layer subsystem that will keep all transactions secure; and
a transaction tracker linked to fraud detection subroutine.
